(19) United States
(12) Patent Application Publication
(10) Pub. No.: US 2006/0021659 A1
(43) Pub. Date: Feb. 2, 2006

(54) Hose adapter incorporating a valve and a method of manufacturing the same

(76) Inventor: Bo Andersson, Cambridge, NY (US)

Correspondence Address: HESLIN ROTHENBERG FARLEY & MESITI PC, 5 COLUMBIA CIRCLE, ALBANY, NY, 12203, US

(21) Appl. No.: 10/903,355

(22) Filed: Jul. 30, 2004

(51) Int. Cl. F16K 15/02

(52) U.S. Cl. 137/515

(57) ABSTRACT

A hose adapter incorporating a valve confined within the hose adapter reduces the number of component parts typically necessary in a fluid line system. The valve is confined within the hose adapter by a machined edge extending radially inward or mating ridges and cavities on the interior surface of the hose adapter and outer surface of the valve.

### FIELD OF THE INVENTION

This invention relates generally to hose adaptors, and more particularly to hose adapters incorporating a valve, such as, for example, a check valve.

### BACKGROUND OF THE INVENTION

Hose adapters are used to, for example, connect a flexible hose (or pipe) to other components in a fluid line such as, for example, a pump submersed in water wells or another flexible hose or a valve. The flexible hose is pushed over a serrated portion on an end portion of a male connector and secured by two hose clamps. Typically, a hose adaptor may include male or female threads and come in a variety of sizes such as, for example, one half inch through four inches in diameter.

Check valves are designed to permit the flow of fluid in one direction while preventing the fluid from flowing in the reverse direction. Conventional check valves utilize a single poppet valve within a casing, which controls the flow of fluid therethrough. This casing is typically installed in the hose line between the pump and the surface of the water well to prevent back flow of water or debris into the pump. The ends of the casing of conventional check valves include female threads to attach to hose adapters that are, in turn, connected to flexible hoses or pipes with the use of hose clamps pushed over the serrated ends.

An illustration of the typical use of a check valve, including the number of parts used, is provided in FIG. 1. As shown, a check valve is currently installed in a fluid line using a check valve casing 10, two male hose adapters 12 connected to the ends of check valve casing 10, and four hose clamps 14 to secure flexible hoses 5 to hose adapters 12. In order to connect this conventional assembly to a pump 16, a third male connector 18 and two additional hose clamps 20 are required. The third male adapter has male threads to mate with the discharge of the pump.

### SUMMARY OF THE INVENTION

The shortcomings of the prior art may be alleviated by using a hose adapter in accordance with one or more principles of the present invention. The hose adapter of the present invention may be used in any type of hydraulic or other fluid flow lines such as, for example, water, fuel, or gas lines, wells, cisterns, pumping outfits or the like. Additionally, other uses may be made of the invention that fall within the scope of the claimed invention but which are not specifically described below.

In one aspect of the invention, there is provided a hose adapter comprising at least a portion of a value confined within an interior cavity of the hose adapter.

In another aspect of the invention, a method of manufacturing a hose adapter comprises providing a valve configured to fit within an interior cavity of said hose adapter, inserting the valve in the interior cavity and forming an edge of the hose adapter to continue the valve within the interior cavity of the hose adapter.

In one embodiment, the valve is confined within the hose adapter by an edge of the hose adapter extending by an edge of the hose adapter extending radially inward toward a longitudinal axis of the hose adapter. In another embodiment, the valve is confined within the hose adapter by mating ridge and cavity formed on the surface of the inner cavity of the hose adapter and the outer surface of the valve.

Additional advantages are provided through the provision of a hose adapter incorporating a valve constructed by the method described and claimed herein. The hose adapter described and claimed herein assures cost savings and reduces installation time by eliminating the need for at least seven additional components, including a check valve casing, four hose clamps, and two hose adapters. Additional features and advantages are realized through the techniques of the present invention. Other embodiments and aspects of the invention are described in detail herein and are considered a part of the claimed invention.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 depicts an exploded view of a conventional system using a check valve casing, two male adapters, four hose clamps and flexible hoses;

FIG. 2 depicts a longitudinal cross-sectional view of one embodiment of a hose adapter incorporating a valve in accordance with the principles of the present invention;

FIGS. 3A-3D depict one embodiment of the sequence of events of a manufacturing process to combine a hose adapter and valve, in accordance with an aspect of the present invention;

FIG. 4 depicts a longitudinal cross-sectional view of one embodiment of a hose adapter incorporating a valve in accordance with the principles of the present invention; and

FIG. 5 depicts an alternative embodiment of a hose adapter incorporating a valve, in accordance with an aspect of the present invention.

### DETAILED DESCRIPTION OF THE EMBODIMENTS OF THE INVENTION

Presented herein is an improved hose adapter that incorporates a valve, and a method of manufacturing the same. There are a variety of hose adapters that can be used in accordance with the principles of the present invention, such as, for example, a male or female adapter, elbow, well seal elbow, coupling, reducing coupling, rope adapter, venture rope adapter, union adapter and the like. The illustrative purposes only, the hose adapter discussed herein is a male adapter.

The type of valve discussed herein that is incorporated into the hose adapter is a check valve, although other types of valves may be utilized. In one embodiment, the type of valve used permits fluid flow in one direction while preventing the same in the opposite direction within the hose adapter, similar to a check valve. This type of valve is effective to, for example, pump out new water wells. In alternative embodiments, the valve incorporated within the hose adapter may restrict the amount of water passing through the hose adapter, similar to a flow orifice valve. This type of valve is effective when two neighbors share a water well and each household agrees to use half of the yield of the well. In this embodiment, each hose or water service will only receive the agreed upon amount of water by limiting the flow rate each household receives or restricting higher flow.

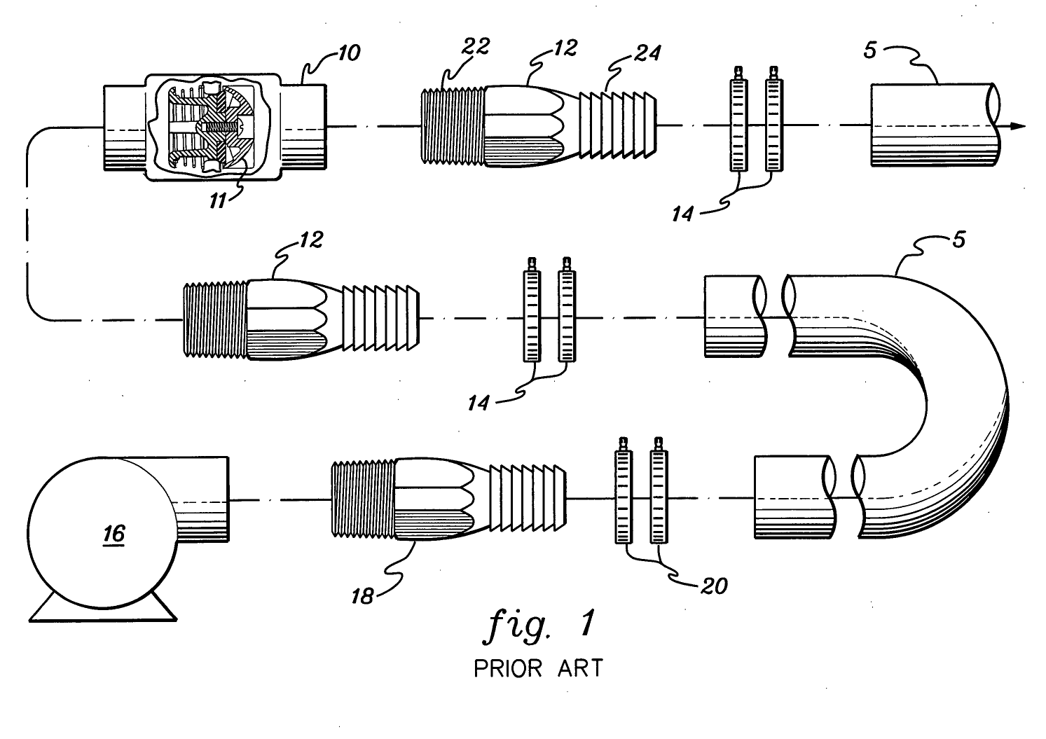

As shown in FIG. 1, conventional check valves have a tubular valve casing 10 and a poppet valve 11 mating with a valve aperture formed by a flange on the inner surface of the valve casing. The poppet valve opens and closes the valve aperture depending on the pressure differential upstream and downstream of the check valve. An example of a conventional check valve casing is described and shown in U.S. Pat. No. 6,581,633, which is hereby incorporated herein by reference.

As illustrated in FIG. 1, conventional check valves are typically installed in a pipe or hose line between a pump 16 and the surface of the water well (not shown) to prevent back flow of water or debris into pump 16. The ends of the body of conventional check valves include female threads.

Conventional hose adapters serve to connect various components of a fluid line together including, for example, two flexible hoses, a pump and a hose, and a hose and a valve. In one example shown in FIG. 1, a conventional hose adapter 12 has a first end with male threads 22 and a second end with a serrated barbed section 24 used to resiliently hold a flexible pipe or hose line 5. Hose clamps 14 are used to assist in holding the flexible pipe or hose line to barbed end sections 24 of the hose adapters. Typically, male threaded end 22 of a hose adapter connects to the female threads within the ends of check valve casing 10 to incorporate the check valve in the pipe or hose line. In alternative embodiments, hose adapters may include two serrated and or two threaded ends.

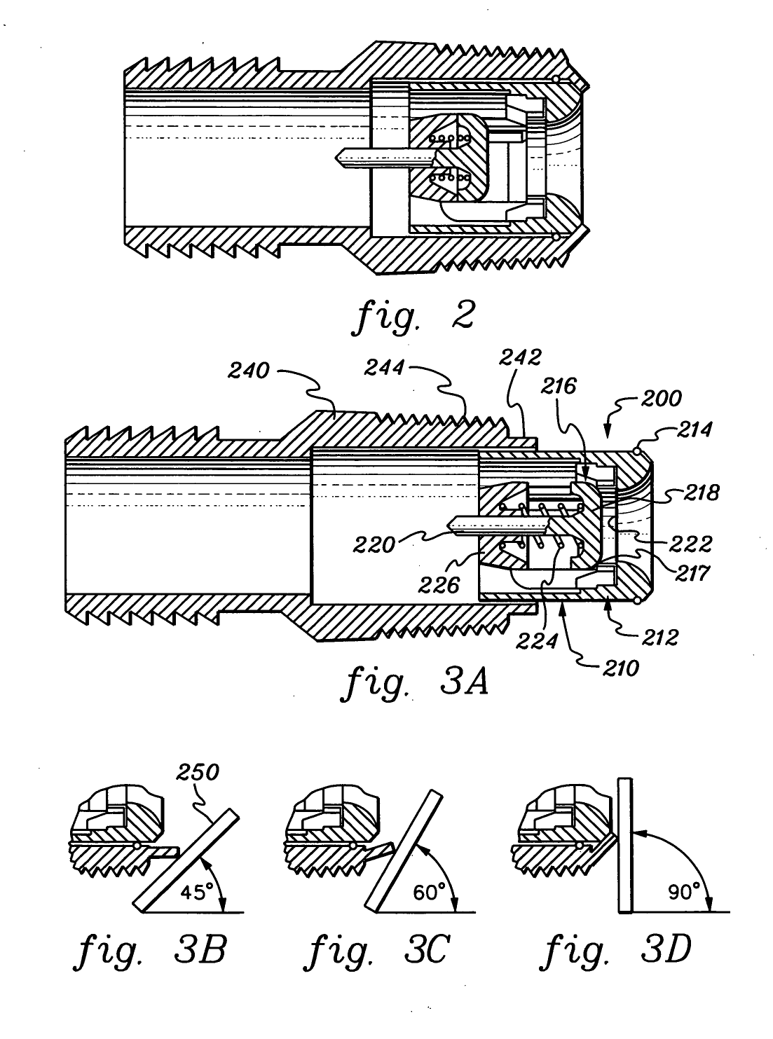

In the illustrative embodiment shown in FIG. 2, the hose adapter constructed in accordance with the principles of the present invention combines a hose adapter and a check valve in one unit, which eliminates the need for three hose adapters, six hose clamps, and a check valve casing. Accordingly, this combination saves cost by reducing installation time and eliminating a number of component parts.

The check valve incorporated within the hose adapter may include a check valve cartridge 200, an illustrative embodiment of which is shown in FIG. 3A. In one embodiment, check valve cartridge 200 comprises a cylindrical housing 210 having an outer surface 212 sized to fit within the inner cavity of the hose adapter. Outer surface 212 of check valve cartridge may include an external o-ring seal 214 to provide sealing between check valve cartridge and the mating cavity of hose adapter.

Check valve cartridge 200 also includes an opening and closing system designed to permit the flow of fluid in one direction while preventing the fluid from flowing in the reverse direction. The closing system utilizes a valve plunger 216 including a head 218 and a center stem 220. Plunger head 216 mates with a valve aperture 222 formed by a flange on an inner surface of a valve seat and seal 217 of valve casing. Valve plunger 216 opens and closes the valve aperture depending on the pressure differential upstream and downstream of the check valve. A spring 224 ensures reliable operation and fast positive sealing even in low back pressure conditions. Center stem 220 of valve plunger 216 is guided up and down by a guide 226 positioned in the center of check valve cartridge. Center stem guide 226 should provide stability to and prevent jamming of valve plunger during operation.

The check valve is normally closed as the spring tension forces valve plunger 216 onto its valve seat 217 shown in FIG. 3A. During forward flow of fluid when the pressure exceeds the spring tension, valve plunger 216 comes off the valve seat to permit fluid to flow through the valve, as shown in FIG. 2. When the pressure downstream of the valve increases causing backpressure or the flow to reverse directions, spring 224 forces valve plunger 216 back to the valve seat and the valve is closed, preventing backflow.

After check valve cartridge 200 is inserted into the hose adapter, the check valve cartridge must be secured in place. In one embodiment, hose adapter 240 may be constructed out of metal and an end portion or leading edge 242 of the hose adapter 240 is machined to create a lip extending radially inward, as shown in FIGS. 3B-3D. In this embodiment, end portion 242 of hose adapter 240 is machined using a steel bar 250 to force or roll over end portion 242 while the hose adapter is in a lathe rotating at, for example, approximately 6,000 rpm. This can be achieved by, for example, pressing a one half inch round steel bar against the edge of the hose adapter at a forty-five degree angle with respect to the longitudinal axis of the hose adapter while the hose adapter body is rotating in the lathe. This causes friction that heats the edge of the hose adapter while conforming the edge to the forty-five degree angle of the steel bar. This application of force and friction can then be repeated at various angles, such as, for example, a sixty degree angle and then, finally, at a ninety degree angle, with respect to the longitudinal axis of the hose adapter. Although, it is understood that different angles may be used as long as the valve cartridge is secured or confined in place within the hose adapter.

In one embodiment, an O-ring is positioned between the outer surface of the check valve cartridge and the inner wall of the hose adapter. As the end portion of hose adaptor is machined into place to secure the valve cartridge within the hose adapter, the O-ring seals tightly between the check valve cartridge and the hose adapter to prevent any leakage.

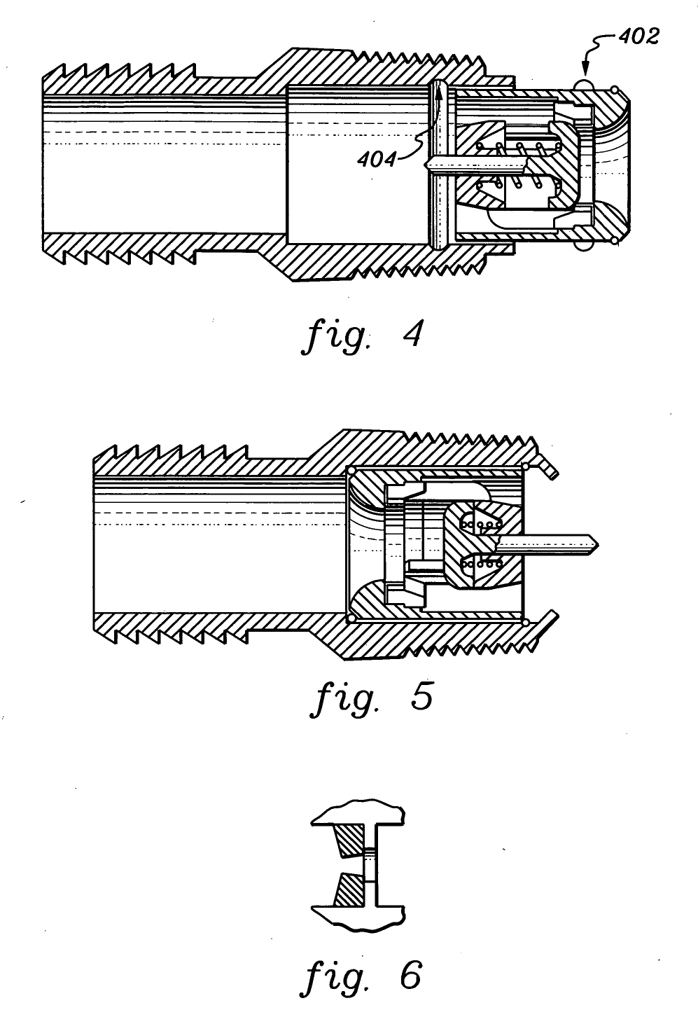

In another embodiment shown in FIG. 4, hose adapter may be formed out of a plastic or composite material. In this embodiment, check valve cartridge includes a circumferential ridge 402 on the outer surface of the valve cartridge. This circumferential ridge mates with a circumferential channel 404 formed in the inner surface of the hose adapter cavity when the check valve cartridge is installed within the hose adapter. In an alternative embodiment, the circumferential ridge exists on the inner surface of the hose adapter cavity and the mating circumferential cavity is formed in the outer surface of the valve cartridge.

Male threaded end 244 of the hose adapter 240 is then assembled with, for example, a female end of a water pump. The machined end portion of the hose adaptor, once assembled with a female end, will provide further support keeping the check valve cartridge in place and to prevent the lip from possibly springing back under high backpressure.

The valve cartridge may be installed at either end (e.g. serrated or threaded end) of the hose adapter and in either direction (See e.g. FIG. 5) depending on the desired direction of flow through the valve. The assembly and machining of the combined hose adapter and valve provides a compact design and flow efficiency. With a check valve cartridge, hydrostatic testing and flow testing demonstrates that the hose adapter constructed in accordance with the principles of the present invention can withstand over three hundred, fifty psi and have normal flow loss across the valve seat.

FIG. 6 illustrates an alternative embodiment of a hose adapter incorporating a valve. As shown, FIG. 6 shows a flow orifice valve inserted in the hose adapter. A flow orifice valve restricts the amount of water passing through the valve. In one application, a flow orifice valve is used to restrict the flow of water between two neighbors that share a well. For example, if the well yields sixteen gallons per minute, each household receives eight gallons of water per minute by installing an eight gallons per minute flow control valve in the water well line going to each household. Each house or water service will only receive the agreed upon amount of water. In an alternative application, a flow control valve is installed in a well water line to allow only a specified amount of water to be pumped out of the well to prevent over pumping. This application maintains a constant water supply from the well while preventing the pump from over pumping the well to protect the pump from damage.

The combined hose adapter and valve constructed in accordance with the principles of the present invention saves space and installation cost by eliminating the need the number of component parts used in conventional applications.

Although preferred embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims.

What is claimed is:

1. A hose adapter, said hose adapter comprising:
at least a portion of a valve confined within an interior cavity of said hose adapter.

2. The hose adapter of claim 1, wherein said valve is confined within the interior cavity of said hose adapter by an edge of the hose adapter extending radially inward toward a longitudinal axis of said hose adapter.

3. The hose adapter of claim 2, wherein said edge of the hose adapter is formed by a machining the edge of said hose adapter.

4. The hose adapter of claim 2, further comprising a seal positioned between said valve and a surface defining the interior cavity of said hose adapter.

5. The hose adapter of claim 1, wherein said valve is confined within the interior cavity of said hose adapter by a ridge formed on either a surface defining the interior cavity of said hose adapter or an outer surface of said valve and a mating cavity formed on the outer of the surface defining the interior cavity of said hose adapter or the outer surface of said valve.

6. A method of manufacturing a hose adapter, said method comprising:
providing a valve configured to fit within an interior cavity of said hose adapter;
inserting said valve in the interior cavity of said hose adapter; and
forming an edge of said hose adapter to confine said valve within the interior cavity of said hose adapter.

7. The method of claim 6, wherein the edge of said hose adapter is formed by pressing a bar against an edge of said hose adapter.

8. The method of claim 7, wherein said hose adapter is rotating while the bar is pressed against the edge of said hose adapter.

9. The method of claim 7, wherein the bar is rotating while being pressed against the edge of said hose adapter.

10. The method of claim 8, wherein the bar is pressed against the edge of said hose adapter at a forty-five degree angle with respect to a longitudinal axis of said hose adapter.

11. The method of claim 9, wherein the bar is pressed against the edge of said hose adapter at a sixty-degree angle with respect to the longitudinal axis of said hose adapter.

12. The method of claim 10, wherein the bar is pressed against the edge of said hose adapter at a ninety-degree angle with respect to the longitudinal axis of said hose adapter.

13. A method of manufacturing a hose adapter, said method comprising:
providing a valve capable of fitting within an interior cavity of said hose adapter;
inserting said valve in the interior cavity of said hose adapter; and
machining an edge of said hose adapter to secure said valve within the interior cavity of said hose adapter.
